(19) United States
(12) Patent Application Publication
(10) Pub. No.: US 2009/0153533 A1
(43) Pub. Date: Jun. 18, 2009

(54) Apparatus and method for driving liquid crystal display panel

(75) Inventors: Kengo Umeda, Kanagawa (JP); Yoshihiko Hori, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/314,588

(22) Filed: Dec. 12, 2008

(30) Foreign Application Priority Data
Dec. 13, 2007 (JP) 2007-322525

(51) Int. Cl. G09G 5/00

(52) U.S. Cl. 345/204

(57) ABSTRACT

A liquid crystal display device is provided with: a liquid crystal display panel and a data driver IC driving the liquid crystal display panel. The liquid crystal display panel includes first and second gate lines, a data line and a pixel including a first sub-pixel connected to the data line and the first gate line and a second sub-pixel connected to the data line and the second gate line. The data driver IC includes: a gamma correction circuitry generating first gamma-corrected data by performing gamma correction on externally-received image data in accordance with a first gamma curve and generating second gamma-corrected data by performing gamma correction on the image data in accordance with a second gamma curve; and a drive circuitry driving the data line in response to the first gamma-corrected data in a first horizontal period and driving the data line in response to the second gamma-corrected data in a second horizontal period following the first horizontal period.

### INCORPORATION BY REFERENCE

This application claims the benefit of priority based on Japanese Patent Application No. 2007-322525, filed on Dec. 13, 2007, the disclosure of which is incorporated herein by reference.

### BACKGROUND OF THE INVENTION

1. Field of the Invention

The present invention relates to a liquid crystal display, and more specifically to a drive technology of a liquid crystal display panel in which each pixel includes a plurality of auxiliary sub-pixels.

2. Description of the Related Art

The viewing angle is one of the significant issues of the liquid crystal display device, and therefore various techniques have been proposed for improving the viewing angle. One known technique for improving the viewing angle is to compose one pixel with two or more sub-pixels and to drive the sub-pixels with different drive voltages. Typically, each pixel is composed of two sub-pixels. Driving the sub-pixels in the same pixel with different driving voltages allows orienting the liquid crystal molecules within the sub-pixels in the different directions. Such drive technique allows correcting and minimizing the distortion of the gamma curve when the image is viewed slantingly. Such technique is disclosed by Sang Soo Kim in a document titled “The World's Largest (82-in.) TFT-LCD,” SID 05 DIGEST, 2005, pp. 1842-1847.

This document discloses a double gate line structure in which each pixel within the liquid crystal display panel is composed of two sub-pixels. FIG. 1 is a conceptual diagram showing a typical configuration of a liquid crystal display panel that adopts the double gate line structure. In the liquid crystal display panel that adopts the double gate line structure, each pixel is composed of two sub-pixels, and two gate lines are arranged along each line of the pixels. One of the paired gate lines is connected to one of the two sub-pixels within each corresponding pixel, and the other is connected to the other of the two sub-pixels. The two sub-pixels within one pixel are connected to the same data line.

More specifically, each dot 101 includes three pixels: an R pixel 102, a G pixel 103, and a B pixel 104 arranged in the horizontal direction. The R pixels 102 are each composed of two R sub-pixels 102A and 102B, the G pixels 103 are each composed of two G sub-pixels 103A and 103B, and the B pixels 104 are each composed of two B sub-pixels 104A and 104B. Two gate lines Gj(A) and Gj(B) are provided for each row of the R, G and B pixels 102, 103 and 104. In addition, one data line Rj is provided for each column of the R pixels 102, one data line Gi is provided for each column of the G pixels 103, and one data line Bi is provided for each column of the B pixels 104. The two R sub-pixels 102A and 102B within the same R pixel 102 are connected to the same data line Rj, the two G sub-pixels 103A and 103B within the same G pixel 103 are connected to the same data line Gj, and the two B sub-pixels 104A and 104B within the same B pixel 103 are connected to the same data line Bj.

As shown in FIG. 2, each sub-pixel includes a TFT (thin film transistor), a liquid crystal capacitor formed between a common electrode VCOM and a pixel electrode, and a retention capacitor formed between the common electrode VCOM and a retaining electrode. For example, the R sub-pixel 102A includes a TFT 105A, a liquid crystal capacitor 106A, and a retention capacitor 107A, and the R sub-pixel 102B includes a TFT 105B, a liquid crystal capacitor 106B, and a retention capacitor 107B. Other sub-pixels are similarly structured.

When a certain gate line Gi(A) is selected in a certain horizontal period, the R main sub-pixel 102A, the G main sub-pixel 103A and the B main sub-pixel 104A connected to the gate line Gi(A) are driven with drive voltages supplied from the data lines Ri, Gi and Bi, respectively. When the adjacent gate line Gi(B) is selected in the next horizontal period, the R sub-pixel 102B, the G sub-pixel 103B and the B sub-pixel 104B connected to the gate line Gi(B) are driven with drive voltages supplied from the same data lines Ri, Gi and Bi, respectively.

In the liquid crystal display panel with the configuration shown in FIGS. 1 and 2, the two sub-pixels are driven with different drive voltages for the same value of the image data. In other words, two sub-pixels within each pixel are driven in accordance with different gamma curves. Therefore, the generation of the drive voltages for driving the two sub-pixels requires gamma corrections in accordance with different gamma curves. In order to provide gamma corrections in accordance with different gamma curves, the liquid crystal display device shown in FIGS. 1 and 2 adopts a special drive method which is not commonly used in common liquid crystal display devices.

Japanese Laid Open Patent Application No. P2007-226242A discloses a technique of driving a liquid crystal display panel of the configuration shown in FIGS. 1 and 2. FIG. 3 is a block diagram showing the configuration of a liquid crystal display device 200 disclosed in this Japanese patent application. The liquid crystal display device 200 is provided with a liquid crystal panel 210 structured as shown in FIGS. 1 and 2, a first storage unit 220, a second storage unit 230, a timing controller 250, a switching unit 260, a first gate driver 270, a second gate driver 280 and a data driver 290. Since an architecture in which the liquid crystal display is constructed with a timing controller IC (Integrated Circuit), a gate driver IC, a data driver IC is one of the common architectures of the liquid crystal displays, the person skilled in the art would understand that the timing controller 250 corresponds to a timing controller IC, the first and second gate driver 270 and 280 correspond to gate driver ICs, and the data driver 150 corresponds to a data driver IC. The first storage unit 220 stores an LUT describing a gamma curve for “high pixels” (namely, the R sub-pixel 102A, the G sub-pixel 103A, and the B sub-pixel 104A) and the second storage unit 230 stores an LUT describing a gamma curve for “low pixels” (namely, the R sub-pixel 102B, the G sub-pixel 103B, and the B sub-pixel 104B). The first and second storage units 220 and 230 are each provided with different LUTs for red (R), green (G), and blue (B) colors.

The liquid crystal display device 200 schematically operates as follows: The timing controller 250 generates image data R′, G′ and B′ from image signals R, G and B, and feeds the image data R′, G′ and B′ to the data driver 290. In the mean time, the switching unit 260 alternately feed the data corresponding to the high pixel gamma curve stored in the first storage unit 220 and the data corresponding to the low pixel gamma curve stored in the second storage unit 230 to the data driver 290. The data driver 290 performs correction on the image data R′, G′ and B′ in accordance with the data received from the switching unit 260, and transforms the corrected image data R′, G′ and B′ into data voltages. The data voltages obtained by the correction in accordance with the data corresponding to the high pixel gamma curve are outputted during a period in which an odd-numbered gate line is activated, and the data voltages obtained by the correction in accordance with the data corresponding to the low pixel gamma curve are outputted during a period in which an even-numbered gate line is activated.

One drawback of the liquid crystal display device 200 of FIG. 3 is the increase in the data transmission amount to the data driver 290 (or the data driver IC). The liquid crystal display device 200 shown in FIG. 3 requires alternately transmitting the data corresponding to the high pixel gamma curve stored in the first storage unit 220 and the data corresponding to the low pixel gamma curve stored in the second storage unit 230 and in addition to the image data R′, G′ and B′. This undesirably increases the data transmission amount to the data driver 290. In order to address this, it is necessary to increase the data transfer rate or to increase the number of signal liens connected to the data driver 290. The increase of the data transfer rate is not preferable, since this undesirably increases the data error rate. It should be especially noted that the length of the data transmission path between a timing controller IC and a data driver IC is increasingly increased recently, due to the growth in size of the liquid crystal display panel. Accordingly, it has become difficult to achieve data transmission between the timing controller IC and the data driver IC at a high frequency. On the other hand, the increase in the number of the signal lines connected to the data driver 290 undesirably increases the loop aperture of the transmission line, resulting in the increase in the EMI noise generated by the transmission line. It is especially the case when the data driver 290 is composed of a plurality of data driver ICs; when signal lines which transmit the data corresponding to the high pixel gamma curve stored in the first storage unit 220 and the low pixel gamma curve stored in the second storage unit 230 are connected to a plurality of data driver ICs, this undesirably increases the EMI noise generated by the transmission line.

### SUMMARY

In an aspect of the present invention, a liquid crystal display device is provided with: a liquid crystal display panel and a data driver IC driving the liquid crystal display panel. The liquid crystal display panel includes first and second gate lines, a data line and a pixel including a first sub-pixel connected to the data line and the first gate line and a second sub-pixel connected to the data line and the second gate line. The data driver IC includes: a gamma correction circuitry generating first gamma-corrected data by performing gamma correction on externally-received image data in accordance with a first gamma curve and generating second gamma-corrected data by performing gamma correction on the image data in accordance with a second gamma curve; and a drive circuitry driving the data line in response to the first gamma-corrected data in a first horizontal period and driving the data line in response to the second gamma-corrected data in a second horizontal period following the first horizontal period.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a conceptual diagram showing an exemplary configuration of a liquid crystal display panel in which each pixel is composed of two sub-pixels;

FIG. 2 is a circuit diagram showing an exemplary configuration of a liquid crystal display panel in which each pixel is composed of two sub-pixels;

FIG. 3 is a block diagram showing an exemplary configuration of a conventional liquid crystal display;

FIG. 4 is a block diagram showing an exemplary configuration of a liquid crystal display device in a first embodiment of the present invention;

FIG. 5 is a block diagram showing an exemplary configuration of a data driver IC in the first embodiment;

FIGS. 6A and 6B are timing charts showing an operation of the data driver IC in the first embodiment;

FIG. 7 is a block diagram showing a configuration of a data driver IC in a second embodiment;

FIGS. 8A and 8B are timing charts showing an exemplary operation of the data driver IC in the second embodiment;

FIG. 9 is a block diagram showing an exemplary configuration of a data driver IC in a third embodiment;

FIGS. 10A and 10B are timing charts showing an exemplary operation of the data driver IC in the third embodiment;

FIG. 11 is a block diagram showing an exemplary configuration of a data driver IC in a fourth embodiment; and

FIGS. 12A and 12B are timing charts showing an exemplary operation of the data driver IC in the fourth embodiment.

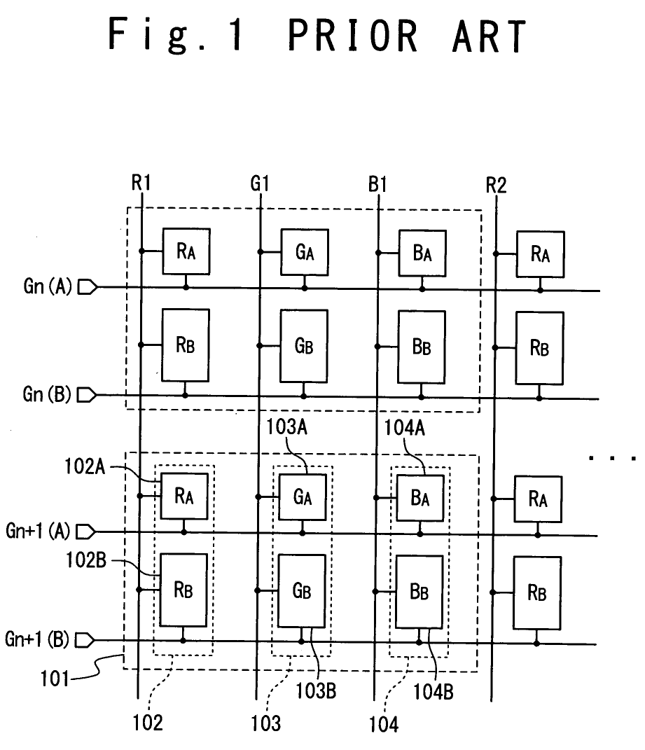

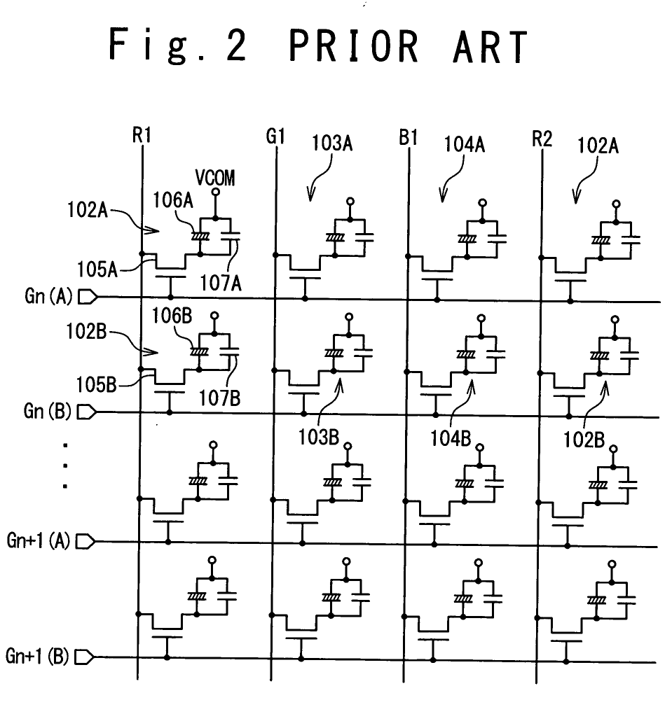

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

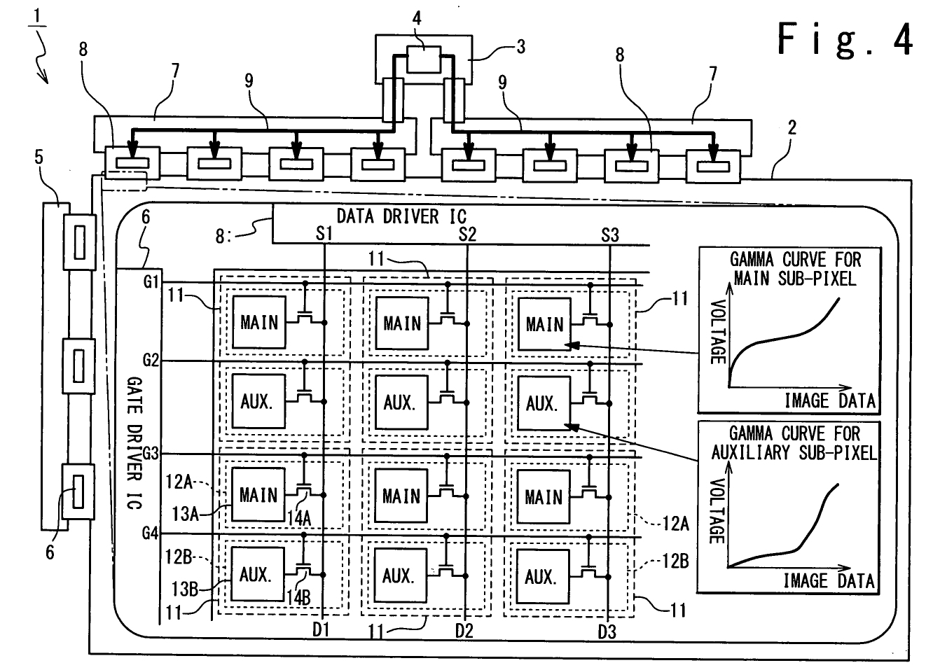

FIG. 4 is a block diagram showing an exemplary configuration of a liquid crystal display 1 of a first embodiment of the present invention. The liquid crystal display 1 is provided with a liquid crystal display panel 2, a timing controller IC 4 provided on a substrate 3, gate driver ICs 6 provided on a substrate 5 and data driver ICs 8 provided on a substrate 7.

The liquid crystal display panel 2 is provided with gate lines G1, G2 . . . , data lines D1, D2, D3, D4 . . . and pixels 11 provided at intersections of the gate and data lines. The liquid crystal display panel 2 of this embodiment is structured so that each pixel 11 includes two sub-pixels: a main sub-pixel 12A and an auxiliary sub-pixel 12B. Two gate lines are provided along each row of the pixels 11. The gate lines G1 and G2 are provided along the topmost column of pixels 11, and the gate lines G3 and G4 are provided along the second topmost column of pixels 11. The main sub-pixels 12A are connected to odd-numbered gate lines G(2i−1), and the auxiliary sub-pixels 12B are connected to even-numbered gate lines G(2i). The main sub-pixel 12A and the auxiliary sub-pixel 12B within the same pixel 11 are commonly connected to the same data line. For example, the main sub-pixel 12A and the auxiliary sub-pixel 12B provided in the leftmost line of pixels 11 are commonly connected to the data line G1, and the main sub-pixel 12A and the auxiliary sub-pixel 12B provided in the second leftmost line of pixels 11 are commonly connected to the data line G2. In this embodiment, pixels 11 aligned along a certain gate line may be referred to as the pixels 11 in one horizontal line.

The main sub-pixels 12A are each provided with a pixel electrode 13A and a TFT 14A, while the auxiliary sub-pixels 12B are each provided with a pixel electrode 13B and a TFT 14B. The gate of the TFT 14A within the main sub-pixel 12A is connected to an odd-numbered gate line G(2i−1) and the gate of the TFT 14B within the auxiliary sub-pixel 12B is connected to an even-numbered gate line G(2i). In addition, the TFT 14A is connected between the pixel electrode 13A and the corresponding data line Di, and the TFT 14B is connected between the pixel electrode 13B and the corresponding data line Di. It should be noted that the TFTs 14A and 14B provided within the main sub-pixel 12A and the auxiliary sub-pixel 12B of the same pixel 11 are connected to the same data line. Although the configuration of the liquid crystal display panel 2 is shown only partially in FIG. 4, the skilled person would appreciate that the whole of the liquid crystal display panel 2 is constructed similarly.

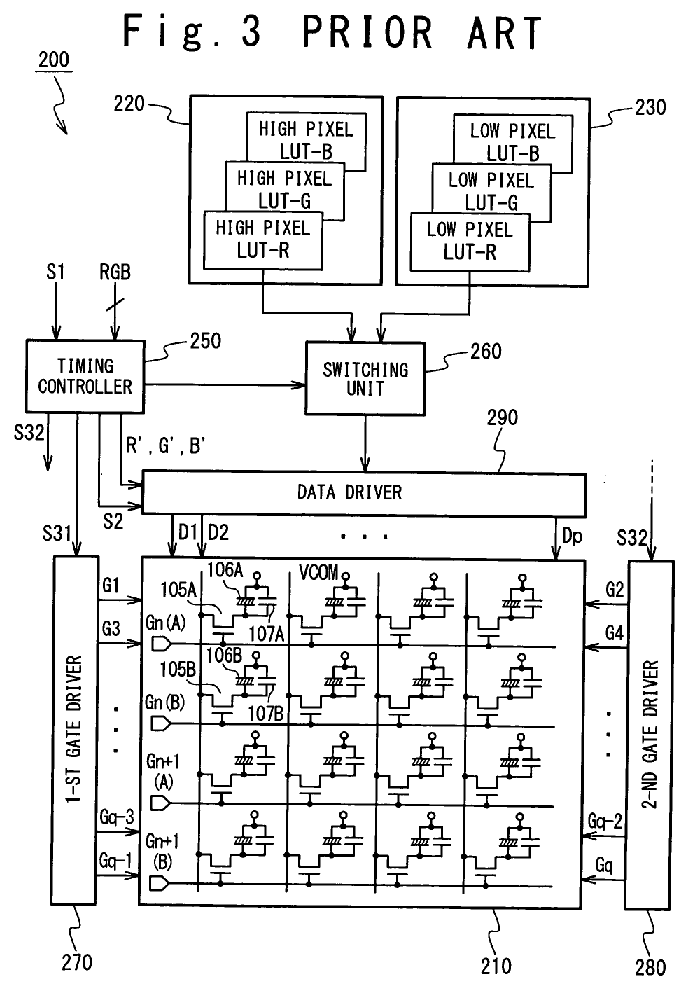

The timing controller IC 4 serially transmits image data 9 to the data driver ICs 8. In this embodiment, the image data 9 are 10-bit data that represent the grayscale level of each pixel with 10 bits. It should be noted that the image data 9 are transferred from the timing controller IC 4 to the data drivers IC 8 before being subjected to the gamma correction, differently from the liquid crystal display device shown in FIG. 3. In addition, the timing controller IC 4 provides timing control of the data drivers IC 8 and the gate driver IC 6 by supplying timing control signals (not illustrated) to the data drivers IC 8 and the gate driver IC 6.

The gate driver ICs 6 sequentially drive gate lines Gi of the liquid crystal display panel 2.

Data lines Di are connected to source outputs Si of the data driver ICs 8, and the data driver ICs 8 drive the data lines Di of the liquid crystal display panel 2 in response to the image data 9. The data driver ICs 8 of this embodiment are each configured to perform gamma corrections in accordance with different gamma curves on the main sub-pixel 12A and the auxiliary sub-pixel 12B within each pixel 11. That is, a data driver IC 8 drives 0the main sub-pixel 12A within a target pixel depending on the data generated by gamma correction on the corresponding image data 9 in accordance with the first gamma curve (hereinafter referred to as a gamma curve “A”), while driving the auxiliary sub-pixel 12B within the target pixel depending on the data generated by gamma correction on the corresponding image data 9 in accordance with the second gamma curve (hereinafter referred to as a gamma curve “B”).

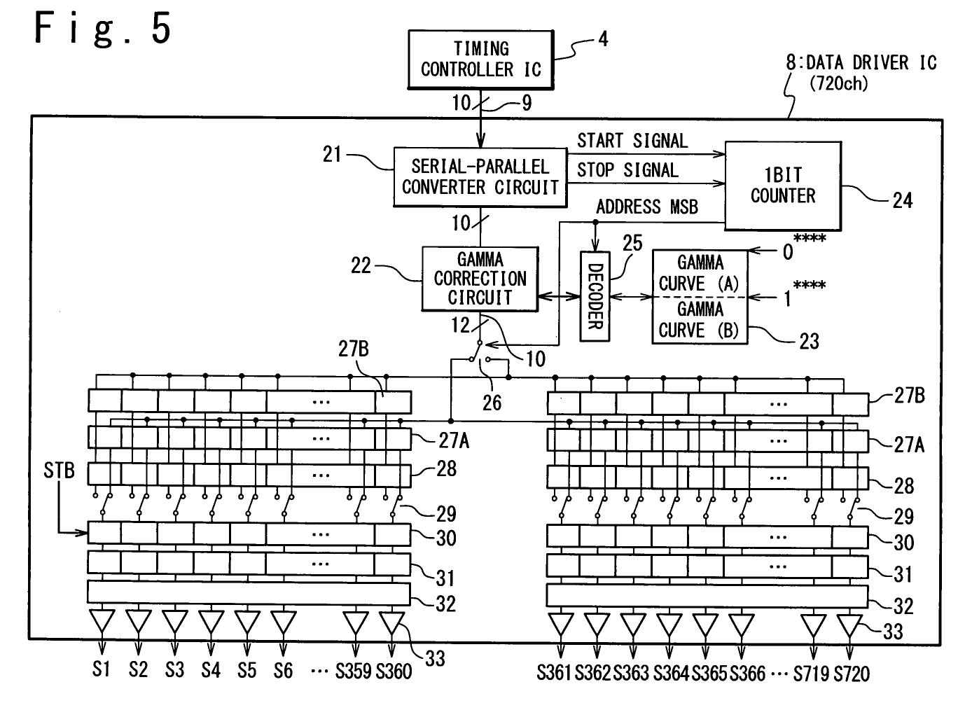

FIG. 5 is a schematic diagram showing an exemplary configuration of the data driver ICs 8. In FIG. 5, shown is an exemplary configuration of the data drives IC 8 for the case where each data driver IC 8 is provided with 720 source outputs S1 to S720; each data driver IC 8 drives 720 pixels 11 in every horizontal period. The data driver ICs 8 are each provided with a serial-parallel converter circuit 21, a gamma correction circuit 22, a parameter storage unit 23, a 1-bit counter 24, a decoder 25, a switch 26, 12-bit latch circuits 27A, 27B, 28, switch circuits 29, 12-bit latch circuits 30, level shifters 31, 12-bit decoders 32, and amplifier circuits 33. The numbers of the latch circuits 27A, 27B, 28, the level shifters 28, the switch circuits 29, the latch circuits 30, the level shifters 31, the decoders 32 and the amplifier circuits 33 are equal to the number of the source outputs of each data driver IC 8. In the configuration of FIG. 5, 720 source outputs S1 to S720 are provided for each data driver IC 8, and the numbers of the latch circuits 27A, 27B, 28, the level shifters 28, the switch circuits 29, the latch circuits 30, the level shifters 31, the decoders 32 and the amplifier circuits 33 are all 720 accordingly.

The serial-parallel converter circuit 21 performs serial-parallel conversion on the image data 9 transmitted serially, and feeds the serial-parallel converted image data 9 to the gamma correction circuit 22.

The gamma correction circuit 22, the parameter storage unit 23, the 1-bit counter 24, and the decoder 25 constitute a gamma correction circuitry for generating gamma-corrected data 10 by performing gamma correction on the image data 9. In this embodiment, the gamma-corrected data 10 are 12-bit data, whereas the image data 9 are 10-bit data.

In detail, the parameter storage unit 23 stores calculation parameters for performing gamma correction in accordance with the gamma curve “A” (namely, gamma correction to be performed on the main sub-pixels 12A) by an approximate calculation, and calculation parameters for performing gamma correction with the gamma curve “B” (namely, gamma correction to be performed on the auxiliary sub-pixels 12B) by an approximate calculation. It should be noted that the calculation parameters are data used to determine the approximate formula used for calculating grayscale values of the gamma-corrected data 10 from the grayscale values of the image data 9. For example, undetermined coefficients included in the approximate formula may be stored in the parameter storage unit 23 as the calculation parameters. The calculation parameters for performing the approximate calculation in accordance with the gamma curve “A” are stored at the addresses whose most significant bit is “1” in the parameter storage unit 23, and the calculation parameters for performing the approximate calculation in accordance with the gamma curve “B” are stored at the addresses whose most significant bit are “0.”

The counter 24 contains a one-bit counter value which specifies whether the access to the parameter storage unit 23 is to be made to the calculation parameters of the gamma curve “A” or to those of the gamma curve “B”. In detail, the counter value of the counter 24 is fed to the decoder 25 as the most significant bit of the destination address of the parameter storage unit 23, to thereby indicate whether the access is to be made to the calculation parameters of the gamma curve “A” or to those of the gamma curve “B”. In detail, when a start signal is activated, the counter 24 starts to toggle the counter value between “0” and “1” at a frequency twice the frequency at which the image data 9 for each pixel are received. The counter value is fed to the decoder 25 to indicate the most significant bit of the address of the parameter storage unit 23. When a stop signal is activated, the counter 24 stops toggling the counter value, and is then reset.

The decoder 25 receives the image data 9 from the gamma correction circuit 22, and selects the destination address of the parameter storage unit 23, acknowledging the counter value received from the counter 24 as the most significant bit of the destination address and the image data 9 received from the gamma correction circuit 22 as the lower bits of the destination address.

The gamma correction circuit 22 generates the gamma-corrected data 10 by performing an approximate gamma correction calculation on the image data 9 by using the calculation parameters received from the selected destination address of the parameter storage unit 23. The generated gamma-corrected data 10 are fed to the latch circuits 26. As described later, the gamma correction circuit 22 alternately outputs the gamma-corrected data 10 corrected in accordance with the gamma curve “A” corresponding to the main sub-pixels 12A and the gamma-corrected data 10 corrected in accordance with the gamma curve “B” corresponding to the auxiliary sub-pixels 12B.

The switch 26 is responsive to the counter value received from the counter 24 for connecting the output of the gamma correction circuit 22 to either the latch circuits 27A or the latch circuits 27B. Such function of the switch 26 allows transmitting gamma-corrected data 10 corrected with the gamma curve “A” to the latch circuits 27A, and transmitting the gamma-corrected data 10 corrected with the gamma curve “B” to the latch circuits 27B.

The latch circuits 27A, 27B, and 28, the switching circuits 29, the latch circuits 30, the level shifters 31, the decoders 32, and the amplifier circuits 33 function as a drive circuitry which drives the data lines D1 to D720 connected to the source outputs S1 to S720 in response to the gamma-corrected data 10.

In detail, the latch circuits 27A receive the gamma-corrected data 10 generated by gamma-correction with the gamma curve “A” from the gamma correction circuit 22 and store the received gamma-corrected data 10 therein. The latch circuits 27A are configured to sequentially receive the gamma-corrected data 10 from left to right. On the other hand, the latch circuits 27B receive the gamma-corrected data 10 from the gamma correction circuit 22 generated by gamma-correction with the gamma curve “B” and the received gamma-corrected data 10 therein. The latch circuits 27B are also configured to sequentially receive the gamma-corrected data 10 from left to right. The latch circuits 28, which have inputs connected to the corresponding outputs of the latch circuits 27B, receive the gamma-corrected data 10 gamma-corrected with the gamma curve “B” from the latch circuits 27B, and store the received gamma-corrected data 10. The switching circuits 29 selectively connect the latch circuits 27A or the latch circuits 28 to the latch circuits 30. The latch circuits 30 are responsive to a strobe signal STB for latching the gamma-corrected data 10 from either the latch circuits 27A or the latch circuits 28. The latch circuits 30 send the latched gamma-corrected data 10 to the decoders 32 through the level shifters 31. The decoders 32 provide D/A conversion for the gamma-corrected data 10 received from the latch circuits 30 to generate analog voltage signals corresponding to the grayscale values indicated by the gamma-corrected data 10. The amplifier circuits 33 drive the data lines D1 to D720 by outputting drive voltages from the source outputs S1 to S720 that have voltage levels corresponding to the voltage levels of the analog voltage signals received from the decoders 32. Basically, the voltage levels of the drive voltages are equal to those of the corresponding analog voltage signals.

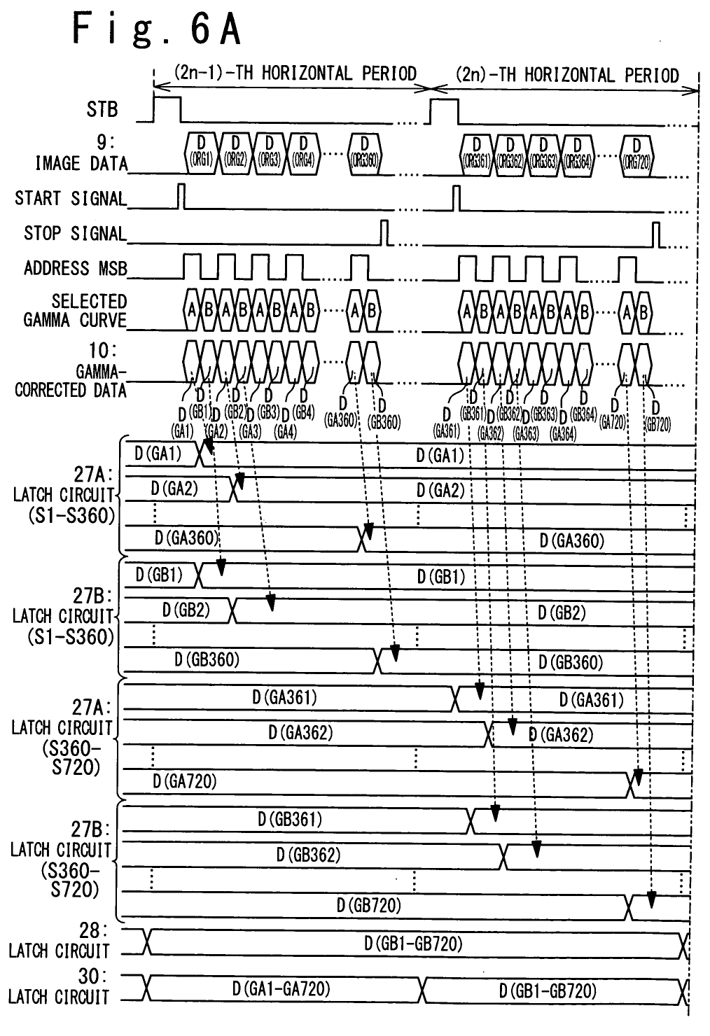

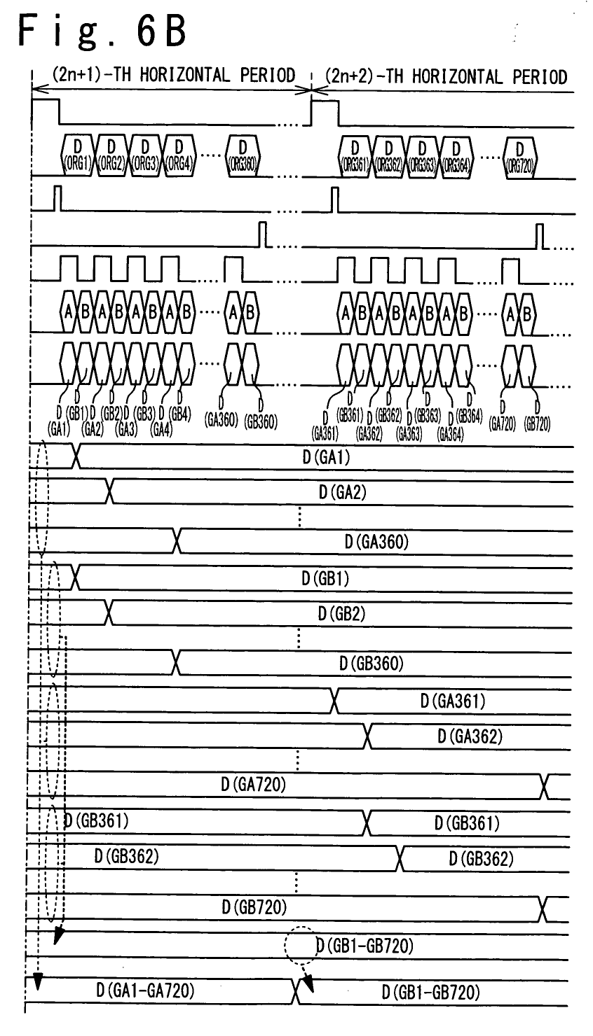

FIGS. 6A and 6B are timing charts showing an exemplary operation of the liquid crystal display 1 in this embodiment. It should be noted that FIGS. 6A and 6B should be acknowledged as being abutted to each other at the broken lines to constitute one timing chart. In the following, the image data 9 corresponding to respective pixels 11 of one horizontal line are described as the image data D(ORG1) to D(ORG720). The gamma-corrected data 10 obtained by performing the gamma correction with the gamma curve “A” corresponding to the main sub-pixels 12A on the image data D(ORGk) are denoted by the symbols D(GAk); the gamma-corrected data 10 obtained by performing the gamma correction with the gamma curve “B” corresponding to the auxiliary sub-pixels 12B on the image data D(ORGk) are denoted by the symbols D(GBk)

In the liquid crystal display 1 of the present embodiment, the 720 image data D(ORG1) to D(ORG720) corresponding to the pixels 11 of one horizontal line are transferred to the data driver IC 8 for every two horizontal periods. That is, image data D(ORG1) to D(ORG360) are transferred to the data driver IC 8 in an odd-numbered horizontal period, and image data D(ORG361) to D(ORG720) are transferred to the data driver IC 8 in an even-numbered horizontal period. In response to the image data D(ORG1) to D(ORG720) transferred to the data driver IC 8 in the (2i−1)-th and (2i)-th horizontal periods, the data driver IC 8 drives the main sub-pixels 12A connected to the gate line G(2i+1) in the (2i+1)-th horizontal period, and drives the auxiliary sub-pixel 12B connected to the gate line G(2i+2) in the (2i+2)-th horizontal period. In the following, a description is given of the operation relevant to the drive of the main sub-pixels 12A connected to the gate line G(2i+1) and of the auxiliary sub-pixels 12B connected to the gate line G(2i+2). Those skilled in the art would appreciate that other main sub-pixels 12A and auxiliary sub-pixels 12B are driven by the same procedure.

(2i−1)-th Horizontal Period

In the (2i−1)-th horizontal period, the image data D(ORG1) to D(ORG360) corresponding to the main sub-pixels 12A connected to the gate line G(2i+1) and the auxiliary sub-pixels 12B connected to the gate line G(2i+2) are transferred to the data driver IC 8. Before the transfer of these image data, a start signal is activated to permit the operation of the counter 24. When the first image data D(ORG1) are then transferred, the output of the counter 24 is set to “1” and the most significant bit of the address is set to “1”, to thereby allow an access to the calculation parameters of the gamma curve “A” stored in the parameter storage unit 23. Furthermore, the decoder 25 receives the image data D(ORG1), and selects the destination address corresponding to the grayscale value indicated by the image data D(ORG1). The gamma correction circuit 22 obtains the calculation parameters of the gamma curve “A” from the selected address, performs approximate gamma-correction operation using the obtained calculation parameters of the gamma curve “A” on the image data D(ORG1), and outputs gamma-corrected data D(GA1) corresponding to the image data D(ORG1).

In response to the output of the counter 24 being set to “1,” the switch 26 connects the output of the gamma correction circuit 22 to the latch circuits 27A. Furthermore, the latch circuits 27A corresponding to the source output S1 is triggered to store the gamma-corrected data D(GA1) in the latch circuit 27A corresponding to the source output S1.

Subsequently, the output of the counter 24 is set to “0” and the most significant bit of the address is set to “0” to allow an access to the calculation parameters of the gamma curve “B” stored in the parameter storage unit 23. The decoder 25 selects the address corresponding to the grayscale value of the image data D(ORG1). The gamma correction circuit 22 obtains the calculation parameters from the selected address, performs approximate gamma-correction operation using the obtained calculation parameters of the gamma curve “B” on the image data D(ORG1), and outputs the gamma-corrected data D(GB1) corresponding to the image data D(ORG1).

In response to the output of the counter 24 being set to “0,” the switch 26 connects the output of the gamma correction circuit 22 to the latch circuits 27B. Furthermore, the latch circuits 27B corresponding to the source output S1 is triggered, and the gamma-corrected data D(GB1) are stored in the latch circuit 27B corresponding to the source output S1.

The gamma correction is also performed on the image data D(ORG2) to D(ORG360) in the same way. Thereby, the gamma-corrected data D(GA1) to D(GA360) corrected with the gamma curve “A” are stored in the latch circuits 27A corresponding to the source outputs S1 to S360, and the gamma-corrected data D(GB1) to D(GB360) corrected with the gamma curve “B” are stored in the latch circuits 27B corresponding to the source outputs S1 to S360. When the transfer of the image data D(ORG360) to the data driver IC 8 is completed, the stop signal is activated to reset the counter 24.

(2i)-th Horizontal Period

In the (2i)-th horizontal period, the image data D(ORG361) to D(ORG720) corresponding to the main sub-pixels 12A connected to the gate line G(2i+1) and the auxiliary sub-pixel 12B connected to the gate line G(2i+2) are transferred to the data driver IC 8. Before the transfer of these image data, the start signal is activated to permit the operation of the counter 24. When the first image data D(ORG361) are then transferred, the output of the counter 24 is set to “1” and the most significant bit of the address is set to “1” to allow an access to the calculation parameters of the gamma curve “A” stored in the parameter storage unit 23. Furthermore, the decoder 25 receives the image data D(ORG361), and selects the address corresponding to the grayscale level indicated by the image data D(ORG361). The gamma correction circuit 22 obtains the calculation parameters of the gamma curve “A” from the selected address, performs approximate gamma-correction operation using the obtained calculation parameters of the gamma curve “A” on the image data D(ORG361), and outputs gamma-corrected data D(GA361) corresponding to the image data D(ORG361).

In response to the output of the counter 24 being set to “1,” the switch 26 connects the output of the gamma correction circuit 22 to the latch circuits 27A. Furthermore, the latch circuit 27A corresponding to the source output S361 is triggered to store the gamma-corrected data D(GA361) in the latch circuit 27A corresponding to the source output S361.

Subsequently, the output of the counter 24 is set to “0” and the most significant bit of the address is set to “0” to allow an access to the calculation parameters of the gamma curve “B” stored in the parameter storage unit 23. The decoder 25 selects the address corresponding to the grayscale value indicated by the image data D(ORG361). The gamma correction circuit 22 obtains the calculation parameters from the selected address, performs approximate gamma-correction operation using the obtained calculation parameters of the gamma curve “B” on the image data D(ORG361), and outputs the gamma-corrected data D(GB361) corresponding to the image data D(ORG361).

In response to the output of the counter 24 being set to “0”, the switch 26 connects the output of the gamma correction circuit 22 to the latch circuits 27B. Furthermore, the latch circuit 27B corresponding to the source output S361 is triggered to store the gamma-corrected data D(GB361) in the latch circuit 27B corresponding to the source output S361.

The gamma correction is also performed on the image data D(ORG362) to D(ORG720) in the same way. Thereby, the gamma-corrected data D(GA361) to D(GA720) corrected with the gamma curve “A” are stored in the latch circuits 27A corresponding to the source outputs S361 to S720, and the gamma-corrected data D(GB361) to D(GB720) corrected with the gamma curve “B” are stored in the latch circuits 27B corresponding to the source outputs S361 to S720. When the transfer of the image data D(ORG720) to the data driver IC 8 is completed, the stop signal is activated to reset the counter 24.

(2i+1)-th Horizontal Period

When the strobe signal STB is pulled up to the high level in the blanking period of the (2i+1)-th horizontal period, the switching circuit 29 connects the latch circuits 27A to the latch circuit 30. In response to the pull-up of the strobe signal STB, the latch circuits 30 latch the gamma-corrected data D(GA1) to D(GA720) stored in the latch circuits 27A; the gamma-corrected data D(GA1) to D(GA720) are transferred from the latch circuits 27A to the latch circuits 30. In parallel to the transfer of the gamma-corrected data D(GA1) to D(GA720) from the latch circuits 27A to the latch circuits 30, the gamma-corrected data D(GB1) to D(GB720) stored in the latch circuits 27B are transferred to the latch circuits 28.

In the (2i+1)-th horizontal period, the source outputs S1 to S720 are driven depending on D(GA1) to D(GA720) transferred to the latch circuits 30, and the gate line G(2i+1) is pulled up. As a result, the main sub-pixels 12A connected to the gate line G(2i+1) is driven depending on the gamma-corrected data D(GA1) to D(GA720) generated by the gamma correction with the gamma curve “A”.

(2i+2)-th Horizontal Period

When the strobe signal STB is pulled up to the high level in the blanking period of the (2i+2)-th horizontal period, the switching circuits 29 connect the latch circuits 28 to the latch circuits 30. In response to the pull-up of the strobe signal STB, the latch circuits 30 latch the gamma-corrected data D(GB1) to D(GB720) stored in the latch circuits 28; the gamma-corrected data D(GB1) to D(GB720) are transferred from the latch circuits 28 to the latch circuits 30.

In the (2i+2)-th horizontal period, the source outputs S1 to S720 are driven depending on D(GB1) to D(GB720) transferred to the latch circuits 30, and the gate line G(2i+2) is pulled up. As a result, the auxiliary sub-pixels 12B connected to the gate line G(2i+2) are driven depending on the gamma-corrected data D(GB1) to D(GB720) generated by the gamma correction with the gamma curve “B”.

With the above-described procedure, the main sub-pixels 12A are driven depending on the gamma-corrected data D(GA1) to D(GA720) generated by the gamma correction with the gamma curve “A,” and the auxiliary sub-pixels 12B are driven depending on the gamma-corrected data D(GB1) to D(GB720) generated by the gamma correction with the gamma curve “B.”

An advantage of the liquid crystal display 1 of the present embodiment lies in the configuration in which the data driver IC 8 performs the gamma correction effectively reduces the data transfer amount to the data driver IC 8. In the liquid crystal display device 200 shown in FIG. 3, the data corresponding to the high-pixel gamma curve stored in the first storage unit 220 and the data corresponding to the low-pixel gamma curve stored in the second storage unit 230 are transferred alternately to the data driver 290, in addition to the image data R′, G′ and B′. This undesirably increases the data transfer amount to the data driver 290. On the other hand, the liquid crystal display 1 of the present embodiment, in which the parameter storage unit 23 storing the data of the gamma curves “A” and “B” is provided within the data driver IC 8, eliminates the need for transferring the data corresponding to the gamma curve to the data driver IC 8 from the outside for performing the gamma correction. Accordingly, the liquid crystal display 1 of the present embodiment effectively reduces the data transfer amount to the data driver IC 8.

It should be noted that colors of respective pixels 11 are not mentioned in the above description of the present embodiment for easy understanding. In a commercially used liquid crystal display panel, the pixels 11 may include pixels of red color (R pixels), pixels of green color (G pixels), and pixel of blue color (B pixels). In this case, it is preferable that different gamma curves are used in the gamma corrections depending on the color of the pixel of interest. The skilled in the art would appreciate that such change is easily realized by preparing the following six sets of calculation parameters in the parameter storage unit 23:

(1) Calculation parameters associated with the gamma curve for the main sub-pixels within the R pixels;

(2) Calculation parameters associated with the gamma curve for the auxiliary sub-pixels within the R pixels;

(3) Calculation parameters of the gamma curve for the main sub-pixels within the G pixels;

(4) Calculation parameters associated with the gamma curve for the auxiliary sub-pixels within the G pixels;

(5) Calculation parameters associated with the gamma curve of the main sub-pixels of the B pixels; and

(6) Calculation parameters associated with the gamma curve of the auxiliary sub-pixels of the B pixels, and by performing addressing to the parameter storage unit 23 in accordance with the colors of the respective pixels 11 of interest.

Although the parameter storage unit 23 is described as storing the calculation parameters for performing the approximate gamma correction operation in the present embodiment described above, LUTs (look-up tables) associated with the gamma curves may be stored in the storage unit 23 instead. In this case, the gamma correction circuit 22 performs table look-up to obtain the gamma corrected data corresponding to the image data from the LUTs corresponding to the associated gamma curves, and outputs the obtained gamma corrected data.

### Second Embodiment

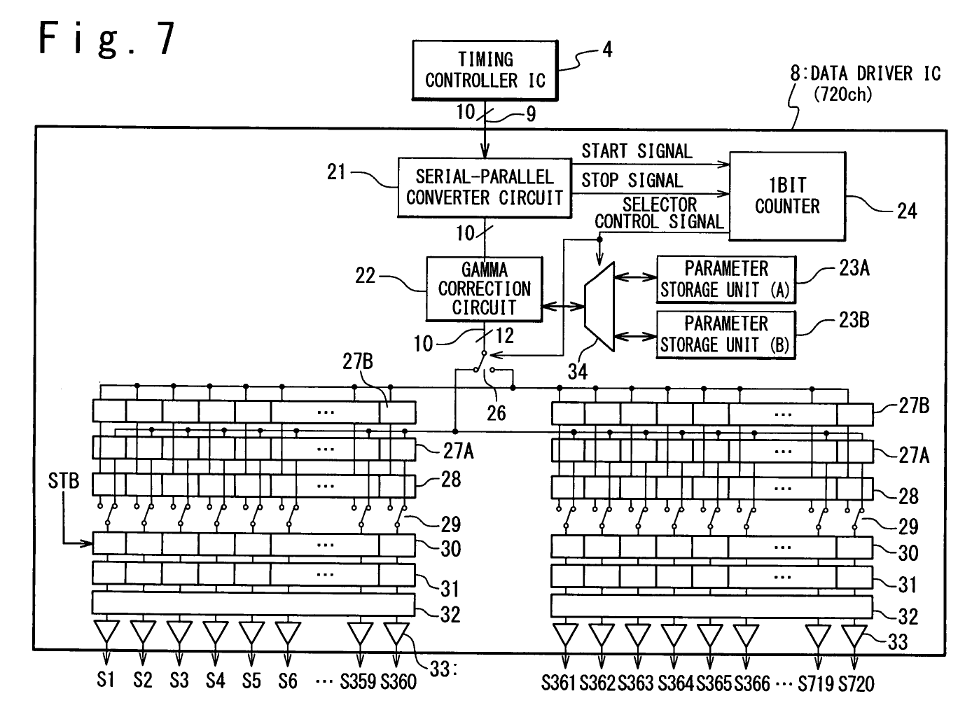

FIG. 7 is a block diagram showing a configuration of the data driver ICs 8 of the liquid crystal display 1 of a second embodiment of the present invention. The configuration of the data driver ICs 8 of the second embodiment is similar to that of the first embodiment. The difference is that a parameter storage unit 23A for storing the calculation parameters used to perform approximate gamma-correction operation with the gamma curve “A” and a parameter storage unit 23B for storing the calculation parameters used to perform approximate gamma correction operation with the gamma curve “B” are prepared instead of the parameter storage unit 23, and a selector 34 is prepared instead of the decoder 25. In the present embodiment, the output of the counter 24 is supplied to the selector 34 as a switching control signal for switching the operation of the selector 34. The selector 34 selects either of the parameter storage units 23A and 23B depending on the output of the counter 24, and connects the selected parameter storage unit to the gamma correction circuit 22. The gamma correction circuit 22 obtains calculation parameters from the address corresponding to the image data 9 of the selected parameter storage unit, performs approximate gamma-correction operation using the obtained calculation parameter on the image data 9, and outputs the resultant gamma-corrected data to either the latch circuits 27A or the latch circuits 27B as the gamma-corrected data 10.

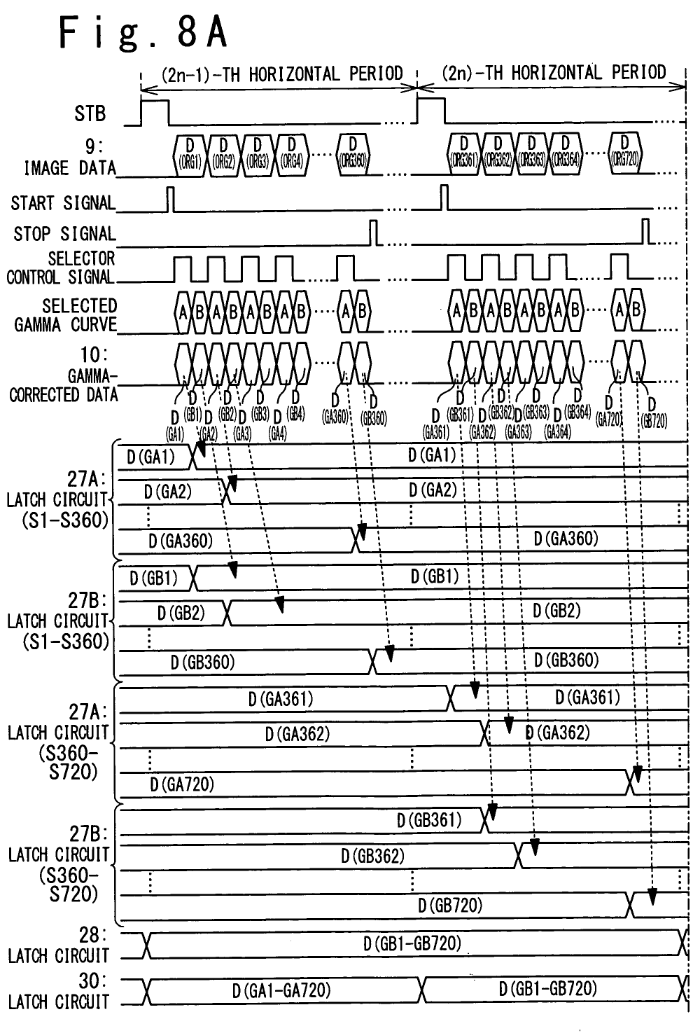

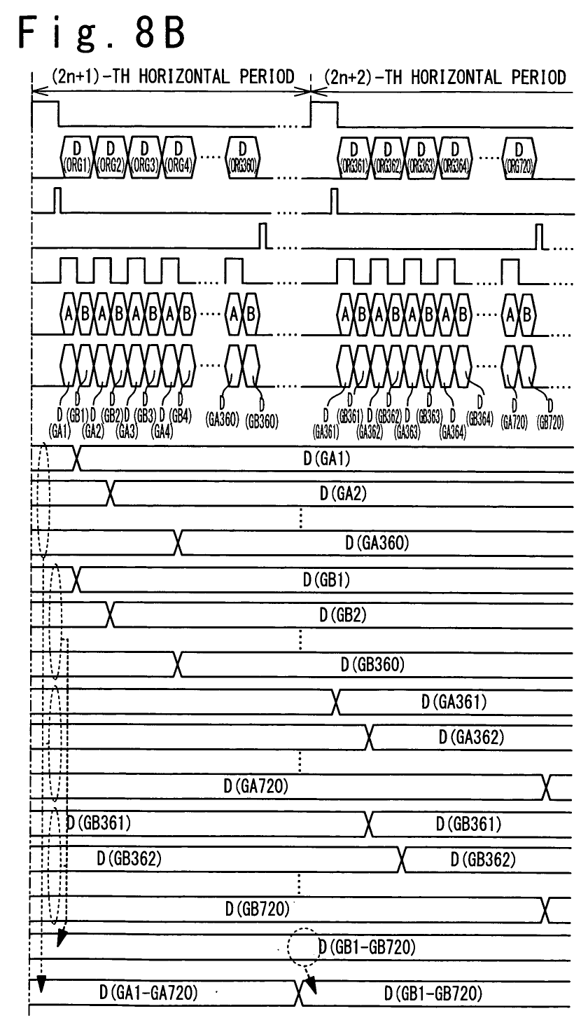

FIGS. 8A and 8B are timing charts showing an exemplary operation of the liquid crystal display device 1 in the second embodiment. It should be noted that FIGS. 8A and 8B should be acknowledged as being abutted to each other at the broken lines to constitute one timing chart. The operation of the liquid crystal display 1 of the second embodiment is essentially the same as that of the first embodiment.

(2i−1)-th Horizontal Period

In the (2i−1)-th horizontal period, the image data D(ORG1) to D(ORG360) corresponding to the main sub-pixels 12A connected to the gate line G(2i+1) and the auxiliary sub-pixels 12B connected to the gate line G(2i+2) are transferred to the data driver IC 8. When the first image data D(ORG1) are transferred, the output of the counter 24 is set to “1” and the switching control signal is set to “1”. Thereby, the parameter storage unit 23A is selected by the selector 34 to allow an access to the calculation parameters used for the approximate gamma-correction operation with the gamma curve “A” in the parameter storage unit 23A. The gamma correction circuit 22 obtains the calculation parameters of the gamma curve “A” from the address of the parameter storage unit 23A corresponding to the grayscale value of the image data D(ORG1), performs the approximate gamma-correction operation using the calculation parameters of the gamma curve “A” on the image data D(ORG1), and outputs the gamma-corrected data D(GA1) corresponding to the image data D(ORG1). The outputted gamma-corrected data D(GA1) are stored in the latch circuit 27A corresponding to the source output S1.

Subsequently, the output of the counter 24 is set to “0” and the switching control signal is set to “0”. Thereby, the parameter storage unit 23B is selected by the selector 34 to allow an access to the calculation parameters used for approximate gamma-correction operation with the gamma curve “B” stored in the parameter storage unit 23B. The gamma correction circuit 22 obtains the calculation parameters from the address of the parameter storage unit 23B corresponding to the grayscale value of the image data D(ORG1), performs the approximate gamma-correction operation using the calculation parameters of the gamma curve “B” on the image data D(ORG1), and outputs the gamma-corrected data D(GB1) corresponding to the image data D(ORG1). The outputted gamma-corrected data D(GB1) are stored in the latch circuit 27B corresponding to the source output S1.

The gamma correction is also performed on the image data D(ORG2) to D(ORG360) in the same way. Thereby, the gamma-corrected data D(GA1) to D(GA360) corrected with the gamma curve “A” are stored in the latch circuits 27A corresponding to the source outputs S1 to S360, and the gamma-corrected data D(GB1) to D(GB360) corrected with the gamma curve “B” are stored in the latch circuits 27B corresponding to the source outputs S1 to S360. When the transfer of the image data D(ORG360) to the data driver IC 8 is completed, the stop signal is activated to reset the counter 24.

(2i)-th Horizontal Period

In the (2i)-th horizontal period, the image data D(ORG361) to D(ORG720) corresponding to the main sub-pixels 12A connected to the gate line G(2i+1) and the auxiliary sub-pixels 12B connected to the gate line G(2i+2) are transferred to the data driver IC 8. The gamma correction is also performed on the image data D(ORG361) to D(ORG720) in the same way as that of the image data D(ORG1) to D(ORG360). Thereby, the gamma-corrected data D(GA361) to D(GA720) corrected with the gamma curve “A” are stored in the latch circuits 27A corresponding to the source outputs S361 to S720, and the gamma-corrected data D(GB361) to D(GB720) corrected with the gamma curve “B” are stored in the latch circuits 27B corresponding to the source outputs S361 to S720.

(2i+1)-th Horizontal Period

When the strobe signal STB is pulled up to the high level in the blanking period of the (2i+1)-th horizontal period, the switching circuits 29 connect the latch circuits 27A to the latch circuits 30. In response to the pull-up of the strobe signal STB, the latch circuits 30 latch the gamma-corrected data D(GA1) to D(GA720) stored in the latch circuits 27A; the gamma-corrected data D(GA1) to D(GA720) are transferred from the latch circuits 27A to the latch circuit 30. In parallel to the transfer of the gamma-corrected data D(GA1) to D(GA720) from the latch circuits 27A to the latch circuits 30, the gamma-corrected data D(GB1) to D(GB720) stored in the latch circuits 27B are transferred to the latch circuits 28.

In the (2i+1)-th horizontal period, the source outputs S1 to S720 are driven depending on D(GA1) to D(GA720) transferred to the latch circuits 30, and the gate line G(2i+1) is pulled up. As a result, the main sub-pixels 12A connected to the gate line G(2i+1) are driven depending on the gamma-corrected data D(GA1) to D(GA360) generated by the gamma correction with the gamma curve “A”.

(2i+2)-th Horizontal Period

When the strobe signal STB is pulled up to the high level in the blanking period of the (2i+2)-th horizontal period, the switching circuits 29 connect the latch circuits 28 to the latch circuits 30. In response to the pull-up of the strobe signal STB, the latch circuits 30 latch the gamma-corrected data D(GB1) to D(GB720) stored in the latch circuits 28; the gamma-corrected data D(GB1) to D(GB720) are transferred from the latch circuits 28 to the latch circuits 30.

In the (2i+2)-th horizontal period, the source outputs S1 to S720 are driven depending on D(GB1) to D(GB720) transferred to the latch circuits 30, and the gate line G(2i+2) is pulled up. As a result, the auxiliary sub-pixels 12B connected to the gate line G(2i+2) is driven depending on the gamma-corrected data D(GB1) to D(GB360) generated by the gamma correction with the gamma curve “B”.

With the above-described procedure, the main sub-pixels 12A is driven depending on the gamma-corrected data D(GA1) to D(GA720) generated by the gamma correction with the gamma curve “A”, and the auxiliary sub-pixels 12B are driven depending on the gamma-corrected data D(GB1) to D(GB720) generated by the gamma correction with the gamma curve “B”.

The liquid crystal display of the second embodiment, as is the case of the liquid crystal display of the first embodiment, effectively reduces the data transfer amount to the data driver IC 8.

Although the parameter storage units 23A and 23B are described as storing the calculation parameters for performing the approximate gamma correction operation in the present embodiment described above, LUTs (look-up tables) associated with the gamma curves may be stored in the parameter storage units 23A and 23B instead. In this case, the gamma correction circuit 22 performs table look-up to obtain the gamma corrected data corresponding to the image data from the LUTs corresponding to the associated gamma curves, and outputs the obtained gamma corrected data.

### Third Embodiment

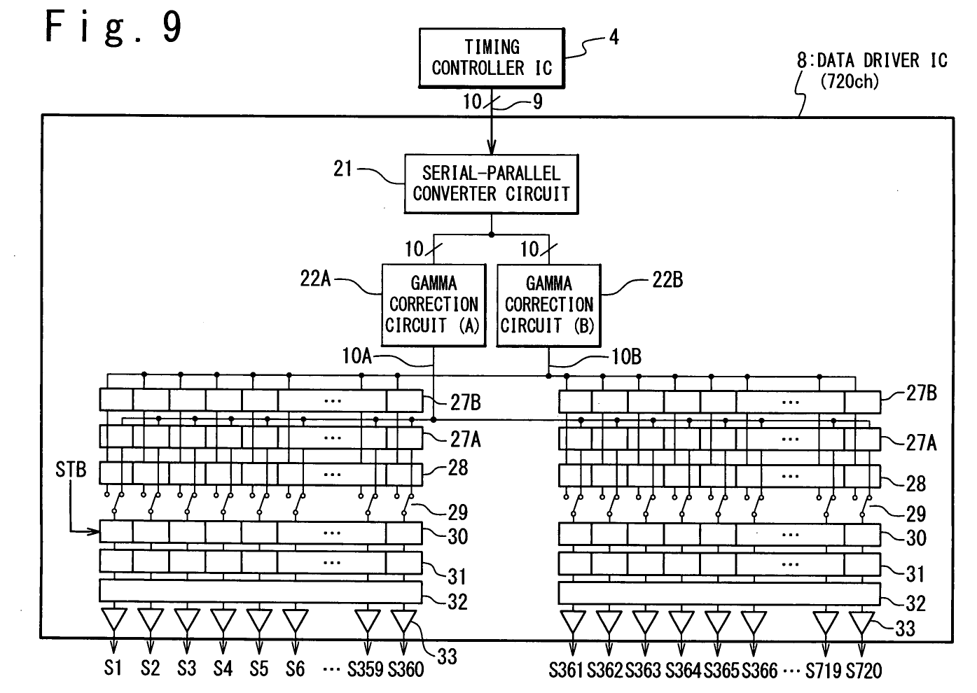

FIG. 9 is a block diagram showing the configuration of the data driver ICs 8 of the liquid crystal display 1 in a third embodiment of the present invention. In the third embodiment, the data driver ICs 8 are each provided with two gamma correction circuits, i.e., gamma-correction circuits 22A and 22B. The gamma correction circuit 22A contains the calculation parameters used to perform the approximate gamma-correction operation with the gamma curve “A”. The gamma operation circuit 22A performs the gamma correction with the gamma curve “A” on the image data 9 by using the calculation parameters of the gamma curve “A” to generate the gamma-corrected data 10A. On the other hand, the gamma correction circuit 22B contains the calculation parameters used to perform the approximate gamma-correction operation with the gamma curve “B.” The gamma operation circuit 22B performs the gamma correction with the gamma curve “B” on the image data 9 by using the calculation parameters of the gamma curve “B” to generate the gamma-corrected data 10B.

The output of the gamma correction circuit 22A is connected to the latch circuits 27A, and the output of the gamma correction circuit 22B is connected to the latch circuits 27B. The gamma-corrected data 10A generated by the gamma correction circuit 22A are stored in the latch circuits 27A and the gamma-corrected data 10B generated by the gamma correction circuit 22B are stored in the latch circuits 27B. It should be noted that signal lines connected between the gamma correction circuit 22A and the latch circuits 27A and signal lines connected between the gamma correction circuit 22B and the latch circuits 27B are provided separately in the present embodiment. As described above, the outputs of the latch circuit 27B are connected to the latch circuits 28, and the switching circuits 29 selectively connects either the latch circuits 27A or the latch circuits 28 to the latch circuits 30. The gamma-corrected data 10A are transferred from the latch circuits 27A to the latch circuits 30, and the gamma-corrected data 10B are transferred from the latch circuit 27B to the latch circuits 30 through the latch circuits 28. The gamma-corrected data 10A and 10B stored in the latch circuits 30 are transferred to the decoders 32 to output drive voltages corresponding to either the gamma-corrected data 10A or the gamma-corrected data 10B from the source outputs S1 to S720.

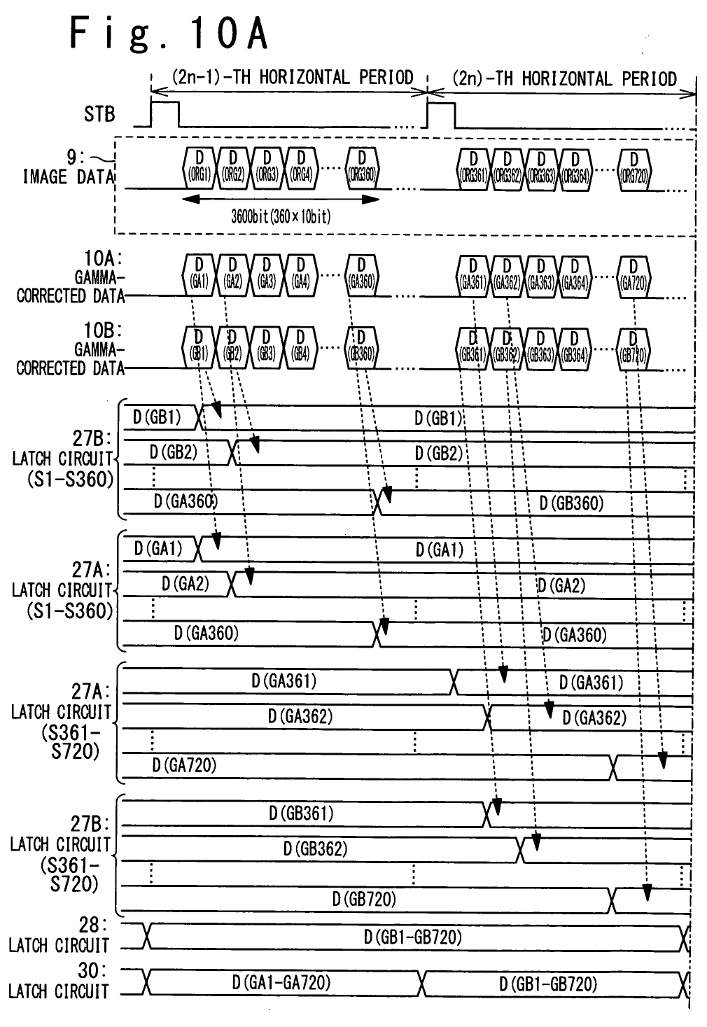

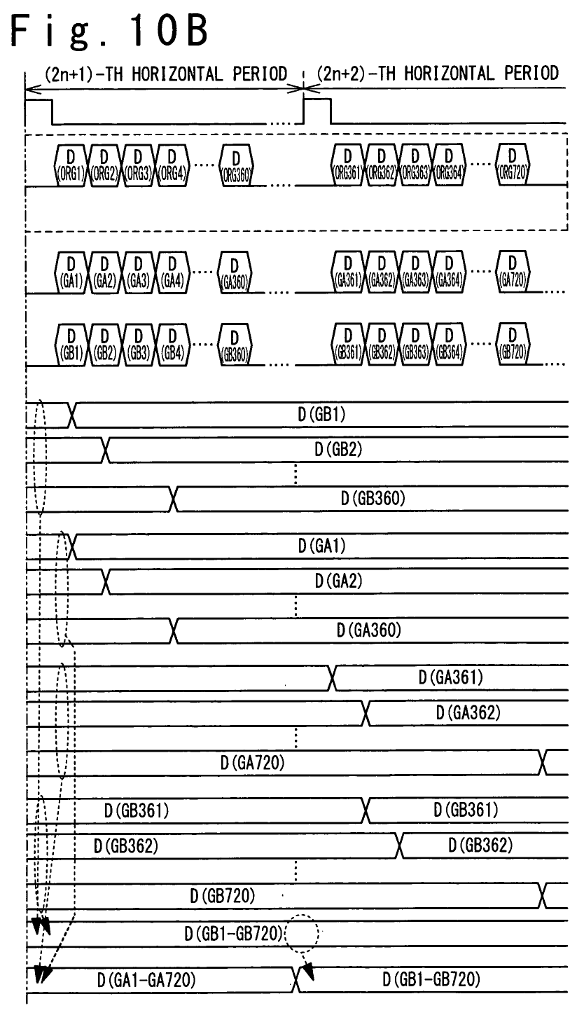

FIGS. 10A and 10B are timing charts showing an exemplary operation of the liquid crystal display 1 of the third embodiment. It should be noted that FIGS. 10A and 10B should be acknowledged as being abutted to each other at the broken lines to constitute one timing chart. In the following, a description is given of the operation relevant to driving of the main sub-pixels 12A connected to the gate line G(2i+1) and the auxiliary sub-pixels 12B connected to the gate line G(2i+2).

(2i−1)-th Horizontal Period

In the (2i−1)-th horizontal period, the image data D(ORG1) to D(ORG360) corresponding to the main sub-pixels 12A connected to the gate line G(2i+1) and the auxiliary sub-pixels 12B connected to the gate line G(2i+2) are transferred to the data driver IC 8. When the first image data D(ORG1) are transferred, the gamma correction circuit 22A performs the gamma correction with the gamma curve “A” on the image data D(ORG1) to generate the gamma-corrected data D(GA1), and the gamma correction circuit 22B performs the gamma correction with the gamma curve “B” on the image data D(ORG1) to generate the gamma-corrected data D(GB1). The gamma-corrected data D(GA1) outputted from the gamma correction circuit 22A are stored in the latch circuit 27A corresponding to the source line S1 and the gamma-corrected data D(GB1) outputted from the gamma correction circuit 22B are stored in the latch circuit 27B corresponding to the source line S1.

The gamma correction is also performed on the image data D(ORG2) to D(ORG360) in the same way. As a result, the gamma-corrected data D(GA1) to D(GA360) corrected with the gamma curve “A” are stored in the latch circuits 27A corresponding to the source outputs S1 to S360, and the gamma-corrected data D(GB1) to D(GB360) corrected with the gamma curve “B” are stored in the latch circuits 27B corresponding to the source outputs S1 to S360.

(2i)-th Horizontal Period

In the (2i)-th horizontal period, the image data D(ORG361) to D(ORG720) corresponding to the main sub-pixels 12A connected to the gate line G(2i+1) and the auxiliary sub-pixels 12B connected to the gate line G(2i+2) are transferred to the data driver IC 8. The gamma correction is also performed on the image data D(ORG361) to D(ORG720) in the same way as that on the image data D(ORG1) to D(ORG360). Thereby, the gamma-corrected data D(GA361) to D(GA720) corrected with the gamma curve “A” are stored in the latch circuits 27A corresponding to the source outputs S361 to S720, and the gamma-corrected data D(GB361) to D(GB720) corrected with the gamma curve “B” are stored in the latch circuits 27B corresponding to the source outputs S361 to S720.

(2i+1)-th Horizontal Period

When the strobe signal STB is pulled up to the high-level in the blanking period of the (2i+1)-th horizontal period, the switching circuit 29 connects the latch circuits 27A to the latch circuits 30. In response to the pull-up of the strobe signal STB, the latch circuit 30 latches the gamma-corrected data D(GA1) to D(GA720) stored in the latch circuits 27A; the gamma-corrected data D(GA1) to D(GA720) are transferred from the latch circuit 27A to the latch circuits 30.

When the gamma-corrected data D(GA1) to D(GA720) are transferred to the latch circuits 30, the source outputs S1 to S720 are driven depending on the transferred gamma-corrected data D(GAL) to D(GA720), and the gate line G(2i+1) is pulled up. As a result, the main sub-pixels 12A connected to the gate line G(2i+1) are driven depending on the gamma-corrected data D(GA1) to D(GA720) generated by the gamma correction with the gamma curve “A”.

In parallel to the transfer of the gamma-corrected data D(GA1) to D(GA720) from the latch circuits 27A to the latch circuits 30, the gamma-corrected data D(GB1) to D(GB720) stored in the latch circuits 27B are transferred to the latch circuits 28 in the (2i+1)-th horizontal period.

(2i+2)-th Horizontal Period

When the strobe signal STB is pulled up to a high-level in the blanking period of the (2i+2)-th horizontal period, the switching circuits 29 connect the latch circuits 28 to the latch circuits 30. In response to the pull-up of the strobe signal STB, the latch circuits 30 latch the gamma-corrected data D(GB1) to D(GB720) stored in the latch circuits 28; the gamma-corrected data D(GB1) to D(GB720) are transferred from the latch circuits 28 to the latch circuits 30.

In the (2i+2)-th horizontal period, the source outputs S1 to S720 are driven depending on D(GB1) to D(GB720) transferred to the latch circuits 30, and the gate line G(2i+2) is pulled up. As a result, the auxiliary sub-pixels 12B connected to the gate line G(2i+2) are driven depending on the gamma-corrected data D(GB1) to D(GB720) generated by the gamma correction with the gamma curve “B.”

With the above-described procedure, the main sub-pixels 12A are driven depending on the gamma-corrected data D(GA1) to D(GA720) generated by the gamma correction with the gamma curve “A,” and the auxiliary sub-pixels 12B are driven depending on the gamma-corrected data D(GB1) to D(GB720) generated by the gamma correction with the gamma curve “B”.

The liquid crystal display device of the third embodiment, as is the case of the liquid crystal display devices of the first and second embodiments, effectively reduces the data transfer amount to the data driver IC 8. In addition, the liquid crystal display device of the third embodiment has an advantage that the gamma-correction circuit is allowed to operate at a slow operation speed as compared with the liquid crystal display devices of the first and second embodiments. It should also be noted, however, that the liquid crystal display devices of the first and second embodiments have an advantage that the hardware scale is reduced compared with the liquid crystal display device of the third embodiment.

Although the gamma-correction circuits 22A and 22B are described as storing the calculation parameters for performing the approximate gamma correction operation in the present embodiment described above, LUTs (look-up tables) associated with the gamma curves may be stored in the gamma-correction circuits 22A and 22B instead. In this case, the gamma correction circuits 22A and 22B perform table look-up to obtain the gamma corrected data corresponding to the image data from the LUTs corresponding to the associated gamma curves, and outputs the obtained gamma corrected data.

### Fourth Embodiment

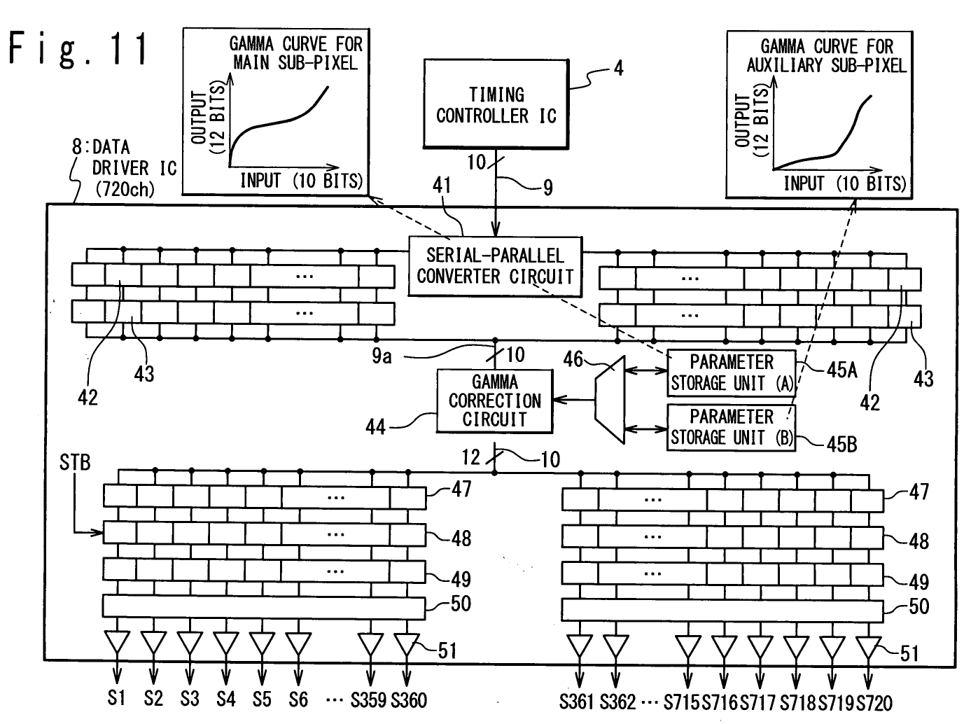

FIG. 11 is a block diagram showing an exemplary configuration of the data driver ICs 8 of the liquid crystal display 1 in a fourth embodiment of the present invention. In the fourth embodiment, the configuration of the data driver ICs 8 is modified from those of the first to third embodiments. In the following, a description is given of the configuration of the data driver ICs 8 in the fourth embodiment with reference to FIG. 11. FIG. 11 shows the configuration of the data drivers IC 8 for the case where each data driver IC 8 has 720 source outputs S1 to S720, i.e., each data driver IC 8 drives 720 pixels 11 in every horizontal period.

The data driver ICs 8 are each provided with a serial-parallel converter circuit 41, 10-bit latch circuits 42, 43, a gamma correction circuit 44, parameter storage units 45A, 45B, a selector 46, 12-bit latch circuits 47, 48, level shifters 49, 12-bit decoders 50, and amplifier circuits 51. The latch circuits 42, 43, 47, and 48, the level shifters 49, and the amplifier circuits 51 are provided as much as there are the source outputs of the data driver IC 8. Since in the configuration of FIG. 11, the 720 source outputs S1 to S720 are provided in the data driver IC 8, the latch circuits 42, 43, 47, and 48, the level shifters 49, the decoders 50, and the 720 amplifier circuits 51 are each provided as much as 720.

The serial-parallel converter circuit 41 performs a serial-to-parallel conversion on the image data 9 serially transferred to the data driver IC 8, and sequentially feeds the serial-parallel converted image data 9 to the latch circuits 42.

The latch circuits 42 and 43 function as a temporal storage circuitry that receives the 10-bit image data 9 sequentially, and temporarily stores the received 10-bit image data 9 therein. The latch circuits 42 and 43 transfer the received image data 9 to the gamma correction circuit 44 in the order of receipt. In detail, the latch circuits 42 sequentially receive the image data 9 transmitted from the serial-parallel converter circuit 41 from left to right. On the other hand, the latch circuits 43 latch simultaneously the image data 9 from the latch circuits 42. The latch circuits 43 transfer the latched image data 9 to the gamma correction circuit 44 sequentially from left to right. In the following, the 10-bit image data transferred from the latch circuits 43 to the gamma correction circuit 44 are referred to as the image data 9a as distinguished from the image data 9 sent to the data driver IC 8.

The gamma correction circuit 44, the parameter storage units 45A, 45B, and the selector 46 operate as a gamma correction circuitry for generating the gamma-corrected data 10 by performing the gamma correction on the image data 9a. In the present embodiment, the image data 9a are 10-bit data, whereas the gamma-corrected data 10 are 12-bit data.

The parameter storage unit 45A contains the calculation parameters used to perform approximate gamma correction operation with the gamma curve “A” and the parameter storage unit 45B contains the calculation parameters used to perform approximate gamma correction operation with the gamma curve “B”. The selector 46 selects one of the parameter storage units 45A and 45B, and connects the selected one to the gamma correction circuit 44. The gamma correction circuit 44 obtains the calculation parameters from the selected parameter storage unit, performs the approximate gamma-correction operation using the obtained calculation parameters on the image data 9a, l and outputs the resultant data to the latch circuits 47 as the gamma-corrected data 10.

The latch circuits 47, 48, the level shifters 49, the decoders 50 and the amplifier circuits 51 function as a drive circuitry which drives the data lines D1 to D720 connected to the source outputs S1 to S720 in response to the gamma-corrected data 10.

In detail, the latch circuits 47 receive the gamma-corrected data 10 from the gamma correction circuit 44 and store the received gamma-corrected data 10 therein. The latch circuits 47 sequentially receive the gamma-corrected data 10 from left to right. In response to the strobe signal STB, the latch circuits 48 receive the gamma-corrected data 10 from the latch circuits 47 and store the received gamma-corrected data 10 therein. The latch circuits 48 send the latched gamma-corrected data 10 to the decoders 50 through the level shifters 49. The decoders 50 perform D/A conversion on the gamma-corrected data 10 received from the latch circuits 48 to generate analog voltage signals corresponding to the grayscale values of the gamma-corrected data 10. The amplifier circuits 51 drive the data lines D1 to D720 by outputting drive voltages from the source outputs S1 to S720. The drive voltages generated by the amplifier circuits 51 have voltage levels corresponding to the voltage levels of the analog voltage signals received from the decoders 50; basically, the voltage levels of the drive voltages are equal to the voltage levels of the corresponding analog voltage signals.

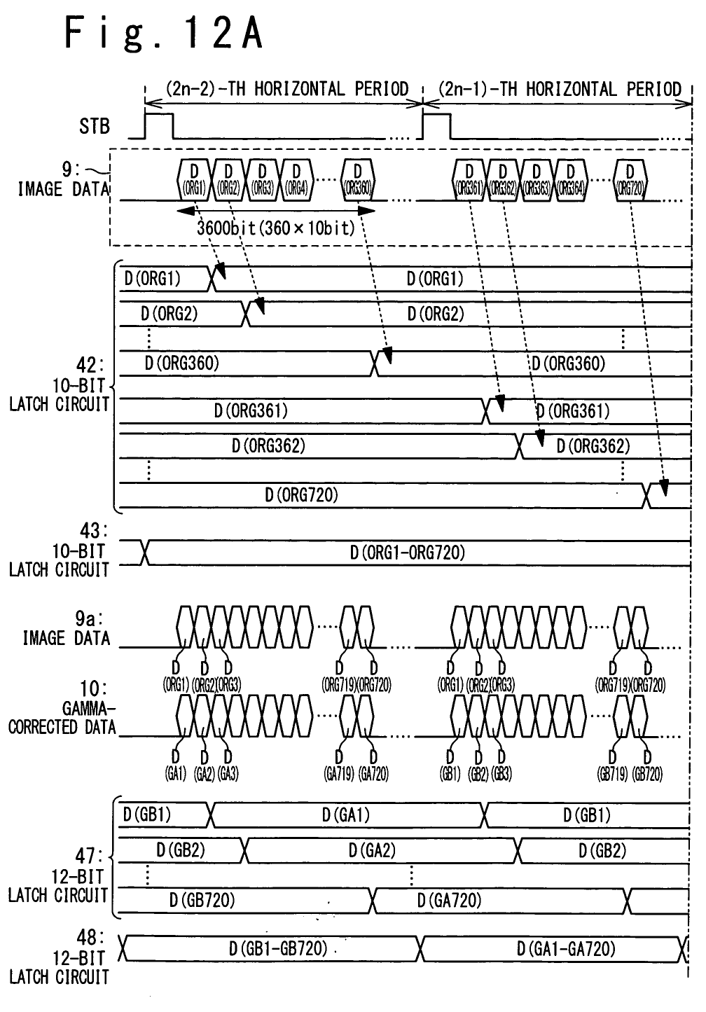

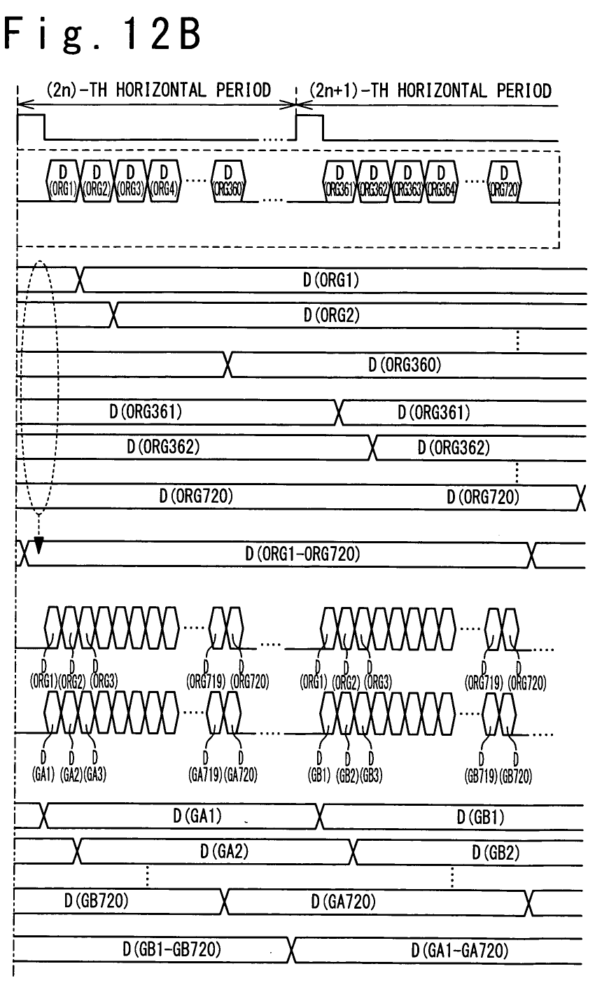

FIGS. 12A and 12B are timing charts showing an exemplary operation of the liquid crystal display 1 of the fourth embodiment. It should be noted that FIGS. 10A and 10B should be acknowledged as being abutted to each other at the broken lines to constitute one timing chart. In the following, a description is given of the operation relevant to driving of the main sub-pixels 12A connected to the gate line G(2i+1) and the auxiliary sub-pixels 12B connected to the gate line G(2i+2).

(2i−2)-th Horizontal Period

In the (2i−2)-th horizontal period, the image data D(ORG1) to D(ORG360) corresponding to the main sub-pixels 12A connected to the gate line G(2i+1) and the auxiliary sub-pixels 12B connected to the gate line G(2i+2) are transferred to the data driver IC 8. The transferred image data D(ORG1) to D(ORG360) are then transferred to the latch circuits 42 corresponding to the source outputs S1 to S360 sequentially and are stored therein.

(2i−1)-th Horizontal Period:

In the (2i−1)-th horizontal period, the image data D(ORG361) to D(ORG720) corresponding to the main sub-pixel 12A connected to the gate line G(2i+1) and the auxiliary sub-pixel 12B connected to the gate line G(2i+2) are transferred to the data driver IC 8. The transferred image data D(ORG361) to D(ORG720) are then transferred to the latch circuits 42 corresponding to the source outputs S361 to S720 sequentially, and are stored therein.

(2i)-th Horizontal Period:

In the (2i)-th horizontal period, the image data D(ORG1) to D(ORG720) stored in the latch circuits 42 are transferred to the latch circuits 43. The latch circuits 43 sequentially transfer the image data D(ORG1) to D(ORG720) to the gamma correction circuit 44.

Upon receiving the image data D(ORG1) from the latch circuits 43, the gamma correction circuit 44 performs the gamma correction on the received image data D(ORG1). In the (2i)-th horizontal period, the parameter storage unit 45A is selected by the selector 34 to allow an access to the calculation parameters of the gamma curve “A” stored in the parameter storage unit 45A. The gamma correction circuit 44 obtains the calculation parameters of the gamma curve “A” from the parameter storage unit 45A, performs the approximate gamma correction operation using the obtained calculation parameters on the image data D(ORG1) received from the latch circuits 43, and outputs the gamma-corrected data D(GA1) corresponding to the image data D(ORG1). The outputted gamma-corrected data D(GA1) are stored in the latch circuit 47 corresponding to the source output S1.

The gamma correction is also performed on the image data D(ORG2) to D(ORG720) in the same way. Thereby, the gamma-corrected data D(GA1) to D(GA720) corrected with the gamma curve “A” are stored in the latch circuits 47 corresponding to the source outputs S1 to S720.

(2i+1)-th Horizontal Period

When the strobe signal STB is pulled up to the high level in the blanking period of the (2i+1)-th horizontal period, the latch circuits 48 latch the gamma-corrected data D(GA1) to D(GA720) stored in the latch circuits 47; the gamma-corrected data D(GA1) to D(GA720) are transferred from the latch circuits 47 to the latch circuits 48.

When the gamma-corrected data D(GA1) to D(GA720) are transferred to the latch circuits 48, the source outputs S1 to S720 are driven depending on the transferred gamma-corrected data D(GA1) to D(GA720), and the gate line G(2i+1) is pulled up. As a result, the main sub-pixels 12A connected to the gate line G(2i+1) are driven depending on the gamma-corrected data D(GA1) to D(GA720) generated by the gamma correction with the gamma curve “A”.

In parallel to the transfer of the gamma-corrected data D(GA1) to D(GA720) to the latch circuits 48, the gamma correction circuit 44 performs the gamma correction with the gamma curve “B” on the image data D(ORG1) to D(ORG720). In detail, in the (2i+1)-th horizontal period, the parameter storage unit 45B is selected by the selector 34 to allow an access to the calculation parameters of the gamma curve “B” stored in the parameter storage unit 45B. The gamma correction circuit 44 obtains the calculation parameters of the gamma curve “B” from the parameter storage unit 45B, performs the approximate gamma correction operation using the obtained calculation parameters on the image data D(ORG1) received from the corresponding latch circuit 43, and outputs the gamma-corrected data D(GB1) corresponding to the image data D(ORG1). The outputted gamma-corrected data D(GB1) are stored in the latch circuit 47 corresponding to the source output S1.

The gamma correction is also performed on the image data D(ORG2) to D(ORG720) in the same way. Thereby, the gamma-corrected data D(GB1) to D(GB720) corrected with the gamma curve “B” are stored in the latch circuits 47 corresponding to the source outputs S1 to S720.

(2i+2)-th Horizontal Period

When the strobe signal STB is pulled up to the high level in the blanking period of the (2i+2)-th horizontal period, the latch circuits 48 latches the gamma-corrected data D(GB1) to D(GB720) stored in the latch circuits 47. Thereby, the gamma-corrected data D(GB1) to D(GB720) are transferred from the latch circuits 47 to the latch circuits 48.

When the gamma-corrected data D(GB1) to D(GB720) are transferred to the latch circuits 48, the source outputs S1 to S720 are driven depending on the transferred image data D(GB1) to D(GB720), and the gate line G(2i+2) is pulled up. As a result, the auxiliary sub-pixels 12B connected to the gate line G(2i+2) are driven depending on the gamma-corrected data D(GB1) to D(GB720) generated by the gamma correction with the gamma curve “B”.

With the above-described procedure, the main sub-pixels 12A are driven depending on the gamma-corrected data D(GA1) to D(GA720) generated by the gamma correction with the gamma curve “A”, and the auxiliary sub-pixels 12B are driven depending on the gamma-corrected data D(GB1) to D(GB720) generated by the gamma correction with the gamma curve “B”.

The liquid crystal display device of the fourth embodiment, as is the case of the liquid crystal display devices of the first to third embodiments, effectively reduce the data transfer amount to the data driver IC 8.

Although the parameter storage units 45A and 45B are described as storing the calculation parameters for performing the approximate gamma correction operation in the present embodiment described above, LUTs (look-up tables) associated with the gamma curves may be stored in the parameter storage units 45A and 45B instead. In this case, the gamma correction circuits 44 perform table look-up to obtain the gamma corrected data corresponding to the image data from the LUTs corresponding to the associated gamma curves, and outputs the obtained gamma corrected data.

It is apparent that the present invention is not limited to the above embodiments, but may be modified and changed without departing from the scope of the invention.

What is claimed is:

1. A liquid crystal display device comprising:
a liquid crystal display panel; and
a data driver IC driving said liquid crystal display panel,
wherein said liquid crystal display panel includes:
first and second gate lines;
a data line; and
a pixel including a first sub-pixel connected to said data line and said first gate line and a second sub-pixel connected to said data line and said second gate line,
wherein said data driver IC includes:
a gamma correction circuitry generating first gamma-corrected data by performing gamma correction on externally-received image data in accordance with a first gamma curve and generating second gamma-corrected data by performing gamma correction on said image data in accordance with a second gamma curve; and
a drive circuitry driving said data line in response to said first gamma-corrected data in a first horizontal period and driving said data line in response to said second gamma-corrected data in a second horizontal period following said first horizontal period.

2. The liquid crystal display device according to claim 1, wherein said gamma correction circuitry includes a storage unit storing data associated with said first gamma curve and data associated with said second gamma curve, and
wherein said gamma correction circuitry generates said first gamma-corrected data by using said data associated with said first gamma curve and generates said second gamma-corrected data by using said data associated with said second gamma curve.

3. The liquid crystal display device according to claim 2, wherein said data associated with said first gamma curve include first calculation parameters indicative of an association of said image data with said first gamma corrected data;
wherein said data associated with said second gamma curve include second calculation parameters indicative of an association of said image data with said second gamma corrected data;
wherein said gamma correction circuitry further includes:
a counter operating in synchronization with reception of said image data;
a decoder for selecting an address of said parameter storage unit depending on a counter value received from said counter and said image data; and
a gamma correction circuit generating said first and second gamma-corrected data,
wherein, when said counter value is a first value, said decoder selects an address of said parameter storage unit at which said first calculation parameters are stored and said gamma correction circuit generates said first gamma correction data by approximate gamma correction operation by using said first calculation parameters, and
wherein, when said counter value is a second value, said decoder selects an address of said parameter storage unit at which said second calculation parameters are stored and said gamma correction circuit generates said second gamma correction data by approximate gamma correction operation by using said second calculation parameters.

4. The liquid crystal display device according to claim 2, wherein said data associated with said first gamma curve include a first LUT indicative of an association of said image data with said first gamma corrected data;
wherein said data associated with said second gamma curve include a second LUT indicative of an association of said image data with said second gamma corrected data;
wherein said gamma correction circuitry further includes:
a counter operating in synchronization with reception of said image data;
a decoder for selecting an address of said parameter storage unit depending on a counter value received from said counter and said image data; and
a gamma correction circuit generating said first and second gamma-corrected data,
wherein, when said counter value is a first value, said decoder selects an address of said parameter storage unit at which said first LUT is stored and a grayscale value obtained from said first LUT is outputted from said gamma correction circuit as said first gamma-corrected data, and
wherein, when said counter value is a second value, said decoder selects an address of said parameter storage unit at which said second LUT is stored and a grayscale value obtained from said second LUT is outputted from said gamma correction circuit as said second gamma-corrected data.

5. The liquid crystal display device according to claim 1, wherein said data driver IC further includes a temporary storage circuitry for externally receiving said image data and transferring said received image data to said gamma correction circuitry,
wherein, in a third horizontal period before said first horizontal period, said image data are transferred from said temporary storage circuitry to said gamma correction circuitry and said first gamma corrected data are generated from said transferred image data, and
wherein, in said first horizontal period, said image data are transferred again from said temporary storage circuitry to said gamma correction circuitry and said second gamma corrected data are generated from said transferred image data.

6. A data driver IC for driving a liquid crystal display panel including first and second gate lines; a data line; and a pixel including a first sub-pixel connected to said data line and said first gate line and a second sub-pixel connected to said data line and said second gate line, said driver IC comprising:
a gamma correction circuitry generating first gamma-corrected data by performing gamma correction on externally-received image data in accordance with a first gamma curve and generating second gamma-corrected data by performing gamma correction on said image data in accordance with a second gamma curve; and
a drive circuitry driving said data line in response to said first gamma-corrected data in a first horizontal period and driving said data line in response to said second gamma-corrected data in a second horizontal period following said first horizontal period.

7. The data driver IC according to claim 6, wherein said gamma correction circuitry includes a storage unit storing data associated with said first gamma curve and data associated with said second gamma curve, and
wherein said gamma correction circuitry generates said first gamma-corrected data by using said data associated with said first gamma curve and generates said second gamma-corrected data by using said data associated with said second gamma curve.

8. The data driver IC according to claim 7, wherein said data associated with said first gamma curve include first calculation parameters indicative of an association of said image data with said first gamma corrected data;
wherein said data associated with said second gamma curve include second calculation parameters indicative of an association of said image data with said second gamma corrected data;
wherein said gamma correction circuitry further includes:
a counter operating in synchronization with reception of said image data;
a decoder for selecting an address of said parameter storage unit depending on a counter value received from said counter and said image data; and
a gamma correction circuit generating said first and second gamma-corrected data,
wherein, when said counter value is a first value, said decoder selects an address of said parameter storage unit at which said first calculation parameters are stored and said gamma correction circuit generates said first gamma correction data by approximate gamma correction operation by using said first calculation parameters, and
wherein, when said counter value is a second value, said decoder selects an address of said parameter storage unit at which said second calculation parameters are stored and said gamma correction circuit generates said second gamma correction data by approximate gamma correction operation by using said second calculation parameters.

9. The data driver IC according to claim 7, wherein said data associated with said first gamma curve include a first LUT indicative of an association of said image data with said first gamma corrected data;
wherein said data associated with said second gamma curve include a second LUT indicative of an association of said image data with said second gamma corrected data;
wherein said gamma correction circuitry further includes:
a counter operating in synchronization with reception of said image data;
a decoder for selecting an address of said parameter storage unit depending on a counter value received from said counter and said image data; and
a gamma correction circuit generating said first and second gamma-corrected data,
wherein, when said counter value is a first value, said decoder selects an address of said parameter storage unit at which said first LUT is stored and a grayscale value obtained from said first LUT is outputted from said gamma correction circuit as said first gamma-corrected data, and
wherein, when said counter value is a second value, said decoder selects an address of said parameter storage unit at which said second LUT is stored and a grayscale value obtained from said second LUT is outputted from said gamma correction circuit as said second gamma-corrected data.

10. The data driver IC according to claim 6, wherein said data driver IC further includes a temporary storage circuitry for externally receiving said image data and transferring said received image data to said gamma correction circuitry,
wherein, in a third horizontal period before said first horizontal period, said image data are transferred from said temporary storage circuitry to said gamma correction circuitry and said first gamma corrected data are generated from said transferred image data, and
wherein, in said first horizontal period, said image data are transferred again from said temporary storage circuitry to said gamma correction circuitry and said second gamma corrected data are generated from said transferred image data.

11. A method of driving a liquid crystal display panel including first and second gate lines; a data line; and a pixel including a first sub-pixel connected to said data line and said first gate line and a second sub-pixel connected to said data line and said second gate line, said method comprising:
externally feeding image data to a data driver IC;
generating first gamma-corrected data within said data driver IC by performing gamma correction on said image data in accordance with a first gamma curve;
generating second gamma-corrected data within said data driver IC by performing gamma correction on said image data in accordance with a second gamma curve;
driving said data line in response to said first gamma-corrected data in a first horizontal period; and
driving said data line in response to said second gamma-corrected data in a second horizontal period following said first horizontal period.
